(19) United States
(12) Patent Application Publication
(10) Pub. No.: US 2022/0349736 A1
(43) Pub. Date: Nov. 3, 2022

(54) AIR FLOW RATE MEASURING DEVICE

(71) Applicant: DENSO CORPORATION, Kariya-city (JP)

(72) Inventors: Hajime MASHITA, Kariya-city (JP); Noboru KITAHARA, Kariya-city (JP)

(21) Appl. No.: 17/865,802

(22) Filed: Jul. 15, 2022

Related U.S. Application Data
(63) Continuation of application No. PCT/JP2020/045681, filed on Dec. 8, 2020.

(30) Foreign Application Priority Data
Jan. 17, 2020 (JP) 2020-005916

(51) Int. Cl. G01F 1/36

(52) U.S. Cl. CPC G01F 1/36

(57) ABSTRACT

An air flow rate measuring device is configured to measure a flow rate of air flowing through a main flow path. The air flow rate measuring device includes a housing, a board, a land portion, and an insulating portion. The housing is provided in the main flow path. The board is provided in the housing. The land portion includes multiple lands via which the board is configured to be mounted with a physical quantity sensor that is configured to detect a physical quantity of air. The insulating portion electrically insulates between the multiple lands against foreign matter or water flowing with the air.

### CROSS REFERENCE TO RELATED APPLICATION

The present application is a continuation application of International Patent Application No. PCT/JP2020/045681 filed on Dec. 8, 2020, which designated the U. S. and claims the benefit of priority from Japanese Patent Application No. 2020-5916 filed on Jan. 17, 2020. The entire disclosures of all of the above applications are incorporated herein by reference.

### TECHNICAL FIELD

The present disclosure relates to an air flow rate measuring device configured to measure a flow rate of air flowing through a main flow path.

### BACKGROUND

Conventionally, there is known an air flow rate measuring device that is installed in a main path through which air flows and that measures a flow rate of air flowing through a main flow path.

### SUMMARY

According to an aspect of the present disclosure, an air flow rate measuring device is configured to measure a flow rate of air flowing through a main flow path. This air flow rate measuring device includes a housing, a board, a land portion, and an insulating portion.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing a vehicle engine system provided with an air flow rate measuring device according to a first embodiment.

FIG. 2 is a front view showing an air flow rate measuring device mounted to an intake pipe.

FIG. 3 is a side view showing the air flow rate measuring device in the direction III of FIG. 2.

FIG. 4 is a side view showing the air flow rate measuring device in the direction IV of FIG. 2.

FIG. 5 is a cross-sectional view showing the air flow rate measuring device taken along a line line V-V in FIG. 2.

FIG. 6 is a cross-sectional view showing a physical quantity measuring flow path in the air flow rate measuring device in taken along a line VI-VI in FIG. 5.

FIG. 7 is an enlarged view showing a portion VII in FIG. 5.

FIG. 8 is a cross-sectional view taken along a line VIII-VIII in FIG. 7.

FIG. 9 is a cross-sectional view showing a physical quantity measuring flow path in an air flow rate measuring device according to a second embodiment.

FIG. 10 is a cross-sectional view taken along a line X-X in FIG. 9.

FIG. 11 is a cross-sectional view showing a physical quantity measuring flow path in an air flow rate measuring device according to a third embodiment.

FIG. 12 is a sectional view taken along line XII-XII of FIG. 11.

FIG. 13 is a cross-sectional view showing a physical quantity measuring flow path in an air flow rate measuring device according to a fourth embodiment.

FIG. 14 is a cross-sectional view taken along a line XIV-XIV of FIG. 13.

FIG. 15 is a cross-sectional view showing a physical quantity measuring flow path in an air flow rate measuring device according to a fifth embodiment.

FIG. 16 is a cross-sectional view taken along a line XVI-XVI in FIG. 15.

FIG. 17 is a cross-sectional view showing a physical quantity measuring flow path in an air flow rate measuring device according to a sixth embodiment.

FIG. 18 is a perspective view showing a mounted component included in the air flow rate measuring device according to the sixth embodiment.

FIG. 19 is an explanatory diagram for explaining a component mounted on a board.

FIG. 20 is a cross-sectional view showing a physical quantity measuring flow path in an air flow rate measuring device according to a seventh embodiment.

FIG. 21 is a cross-sectional view showing a physical quantity measuring flow path in an air flow rate measuring device according to an eighth embodiment.

FIG. 22 is a cross-sectional view showing an air flow rate measuring device according to a ninth embodiment.

FIG. 23 is an arrow view viewed along a XXIII direction in FIG. 22.

FIG. 24 is a cross-sectional view showing an air flow rate measuring device according to a tenth embodiment.

FIG. 25 is a view showing a state in which the air flow rate measuring device according to the eleventh embodiment is attached to an intake pipe.

FIG. 26 is a cross-sectional view showing an air flow rate measuring device according to a twelfth embodiment.

FIG. 27 is an arrow view viewed along a XXVII direction in FIG. 26.

FIG. 28 is a cross-sectional view showing an air flow rate measuring device according to a thirteenth embodiment.

### DETAILED DESCRIPTION

Hereinafter, examples of the present disclosure will be described.

According to an example of the present disclosure, an airflow rate measuring device is installed in a main path through which air flows for measuring a flow rate of air flowing through a main flow path. The air flow rate measuring device includes a housing installed in a main flow path and a printed circuit board provided in a sub-flow path formed in the housing. A flow rate sensor, a pressure sensor, a humidity sensor, and the like are mounted on the board. Thereby, this air flow rate measuring device is configured to measure a pressure and a humidity of air in addition to a flow rate of the air flowing through the main flow path.

In general, the air flow rate measuring device may have various variations corresponding to a vehicle type and the like. One of the variations of the air flow rate measuring device requires measurement of a pressure or a humidity, and other variations does not require measurement of a pressure or a humidity. In a case where multiple types boards are prepared, such that a physical quantity sensor such as a pressure sensor or a humidity sensor mounted on the board and the physical quantity sensor that are not mounted on the board, a manufacturing cost increases as the types of boards increase.

On the other hand, according to an example of the present disclosure, in an air flow rate measuring device, in a case where the same board is used for the type in which the physical quantity sensor is mounted on the board and the type in which the physical quantity sensor is not mounted, the following issues may occur. That is, this the configuration, in the case of the type that the physical quantity sensor is not mounted on the board, a land portion formed on the board for mounting the physical quantity sensor on the board is exposed to the air. In that case, when foreign matter or water flowing with air adheres to the land formed on the board, a wiring of the board may be short-circuited.

According to an example of the present disclosure, it is an air flow rate measuring device configured to measure a flow rate of air flowing through a main flow path. This air flow rate measuring device includes a housing, a board, a land portion, and an insulating portion. The housing is provided in a main flow path. The board is provided in the housing. The land portion includes a plurality of lands on which a physical quantity sensor for detecting a physical quantity of air is configured to be mounted on the board. The insulating portion electrically insulates between the plurality of lands to foreign matter or water flowing with air.

According to this configuration, in a case where the physical quantity sensor is not mounted on the board, the electrical conduction between the plurality of lands is insulated by the insulating portion. Therefore, the air flow rate measuring device enables to use the same board in a type provided with the physical quantity sensor for detecting the physical quantity of air and a type not provided with the physical quantity sensor. Therefore, this air flow rate measuring device can prevent an increase in the types of boards and reduce manufacturing costs.

Here, a parenthesized reference symbol attached to each constituent element or the like shows an example of the correspondence of the constituent element or the like and a specific constituent element or the like described in an embodiment to be described later.

Embodiments of the present disclosure will now be described with reference to the drawings. In the following embodiments, the same or equivalent parts are denoted by the same reference numerals as each other, and explanations will be provided to the same reference numerals. In the following description, when terms of upper, lower, left, right and vertical are used, those terms are used for convenience of explanation and do not limit the position and the orientation when the air flow rate measuring device is mounted on the vehicle are used.

### First Embodiment

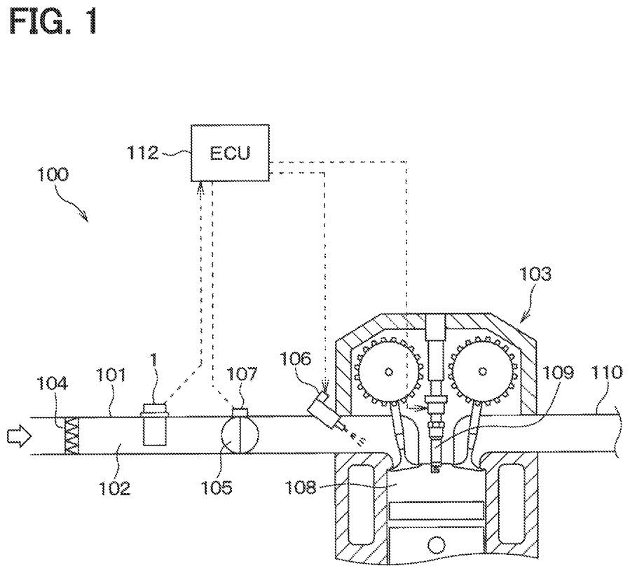

A first embodiment will be described with reference to the drawings. As shown in FIG. 1, an air flow rate measuring device of the present embodiment is an air flow meter 1 provided in an intake pipe 101 constituting an intake system of a vehicle engine system 100. The air flow meter 1 is attached such that a part of the air flow meter 1 is inserted into an intake flow path 102 as a main path formed inside the intake pipe 101. The air flow meter 1 measures a flow rate of air flowing through the intake flow path 102 (that is, an amount of air drawn into an internal combustion engine 103). The air flow meter 1 may be configured to measure various physical quantities such as an air pressure, a humidity, and a temperature of air flowing through the intake flow path 102 in addition to the flow rate of the air, depending on the vehicle type to be mounted.

First, a general configuration of the vehicle engine system 100 to which the air flow meter 1 is attached will be described.

In addition to the air flow meter 1, the intake pipe 101 is provided with an air cleaner 104, a throttle valve 105, an injector 106, and the like. The air cleaner 104 removes foreign substances such as sand and dust contained in the air flowing through the intake flow path 102. The air flow meter 1 is attached to the downstream side of the air cleaner 104. It is noted that, the air supplied to the air flow meter 1 may contain fine foreign matter and water that have passed through the air cleaner 104.

The throttle valve 105 is provided on the downstream side of the air flow meter 1 and controls the amount of intake air. An opening degree of the throttle valve 105 is detected by a throttle sensor 107. The injector 106 injects and supplies fuel to a combustion chamber 108 of the internal combustion engine 103.

Air-fuel mixture supplied to the fuel chamber is ignited by a spark plug 109 and is burned. Exhaust gas burned in the combustion chamber 108 is discharged to the outside of the vehicle through an exhaust pipe 110.

Information measured by vehicle-mounted sensors such as the air flow meter 1 is transmitted to an electronic control device (hereinafter referred to as an ECU) 112 of the vehicle engine system 100. The ECU 112 includes a microcomputer including a storage unit such as a processor, a ROM, and a RAM, and peripheral circuits thereof. Based on the information, the ECU 112 performs a control of each part of the vehicle engine system 100, such as a control of the fuel injection amount by the injector 106 and a control of an EGR amount. The storage unit of the ECU 112 is a non-transitory tangible storage medium.

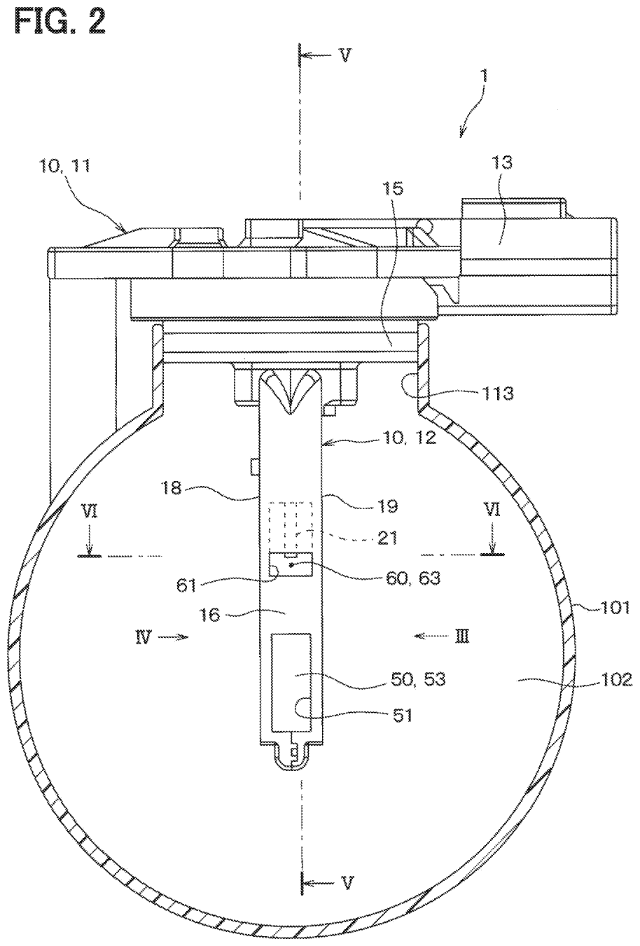

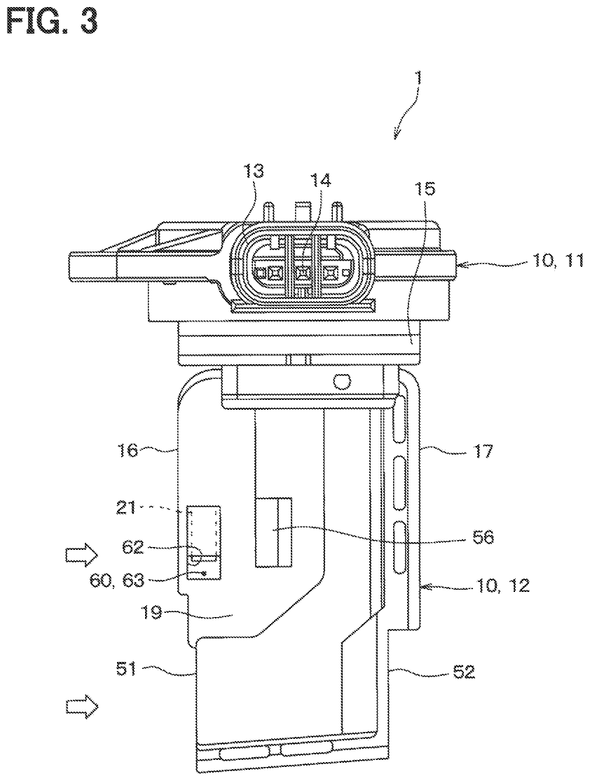

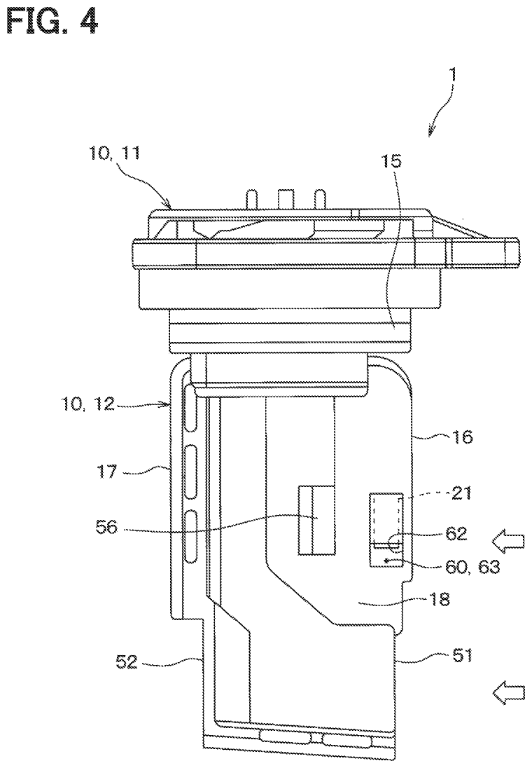

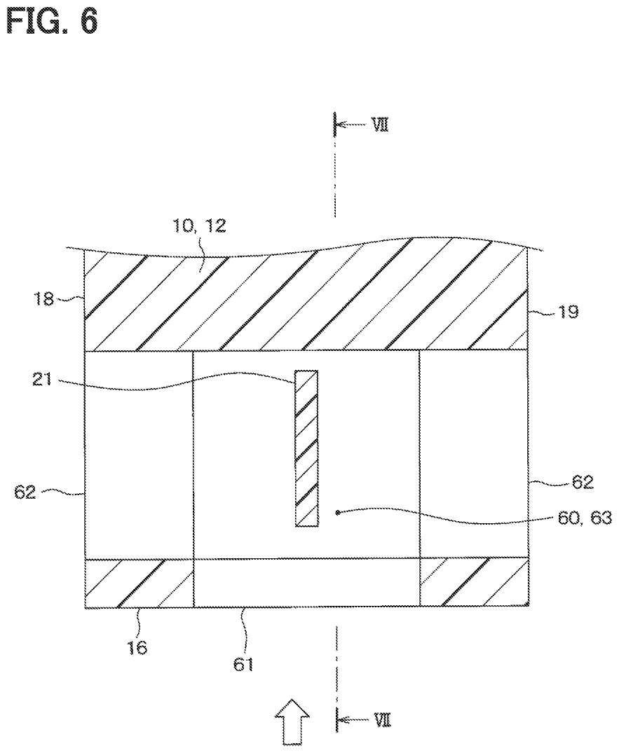

Next, the configuration of the air flow meter 1 will be described with reference to FIGS. 2 to 8.

The air flow meter 1 of the present embodiment includes a housing 10, boards 20 and 21, a land portion 30, a resin coating 40 as an insulating portion, and the like.

As shown in FIGS. 2 to 4, the intake pipe 101 is provided with an insertion hole 113 for mounting the air flow meter 1 therethrough. The housing 10 includes a flange portion 11 fixed to the inner wall of the insertion hole 113 of the intake pipe 101, and a housing main body portion 12 held by the flange portion 11 and inserted into the intake flow path 102. The flange portion 11 and the housing main body portion 12 are integrally formed.

The flange portion 11 is formed in a disk shape on one side of the housing main body portion 12. The flange portion 11 has a portion opposite to the housing main body portion 12 and arranged at the outside of the intake pipe 101. The flange portion 11 has a portion on the side of the housing main body portion 12 and is fitted to the inner wall of the insertion hole 113 provided in the intake pipe 101. A connector 13 is provided at a portion of the flange portion 11 located outside the intake pipe 101. Terminals 14 are provided inside the connector 13. The terminals 14 are electrically connected to wirings of the boards 20 and 21. An O-ring 15 is provided between a portion of the flange portion 11 that is fitted to the inner wall of the insertion hole 113 and the inner wall of the insertion hole 113.

The housing main body portion 12 is a portion arranged inside the intake pipe 101. The housing main body portion 12 is formed in a plate shape having a predetermined thickness. The housing main body portion 12 has a front surface 16 arranged on the upstream side of the intake flow path 102, a rear surface 17 arranged on the downstream side of the intake flow path 102, and a right side surface 18 and a left side surface 19 connecting the front surface 16 with the rear surface 17. The front surface 16 and the rear surface 17 may have a curved shape capable of reducing air resistance or may have a flat shape.

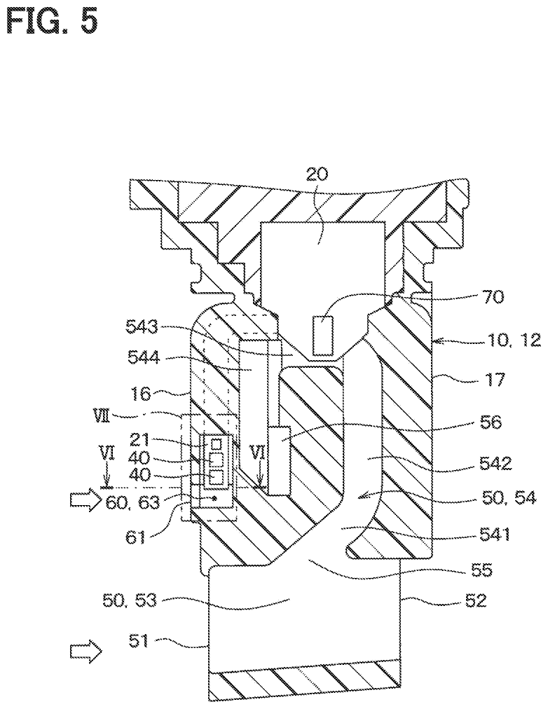

As shown in FIG. 5, a flow rate measuring flow path 50 and a physical quantity measuring flow path 60 are formed in the housing main body portion 12.

The flow rate measuring flow path 50 has a sub-flow path 53 that communicates a sub-flow path inlet 51 with a sub-flow path outlet 52, and a branch flow path 54 that branches from the sub-flow path 53. The sub-flow path inlet 51 is an air inlet that opens in the front surface 16 of the housing main body portion 12 and takes in air from the intake flow path 102 into the flow rate measuring flow path 50. The sub-flow path outlet 52 is an air discharge port that opens in the rear surface 17 of the housing main body portion 12 and discharges air from the flow rate measuring flow path 50 to the intake flow path 102. The sub-flow path inlet 51 and the sub-flow path outlet 52 are formed so that at least a part thereof overlaps with each other when viewed from the central axis of the intake flow path 102. In this way, the foreign matter contained in the air taken into the flow rate measuring flow path 50 from the sub-flow path inlet 51 is discharged from the sub-flow path outlet 52 due to its inertial force.

The branch flow path 54 is a flow path that communicates a branch flow path inlet 55 provided in the middle of the sub-flow path 53 with a branch flow path outlet 56 respectively provided on the right side surface 18 and the left side surface 19 of the housing main body portion 12. The branch flow path 54 has an introduction portion 541, a rear vertical portion 542, a folded portion 543, and a front vertical portion 544. The introduction portion 541 communicates with the branch flow path inlet 55. The introduction portion 541 extends upward from the branch flow path inlet 55 and extends from the branch flow path inlet 55 toward the rear surface 17. The rear vertical portion 542 extends upward from an end of the introduction portion 541 opposite to the branch flow path inlet 55. The folded portion 543 extends in a direction toward the front surface 16 from the end portion of the rear vertical portion 542 opposite to the introduction portion 541. The front vertical portion 544 extends downward from the end of the folded portion 543 opposite to the rear vertical portion 542. The branch flow path outlet 56 is provided at an end of the front vertical portion 544 opposite to the folded portion 543. The branch flow path outlet 56 is open in each of the right side surface 18 and the left side surface 19 of the housing main body portion 12.

It should be noted that a portion of the sub-flow path 53 on the downstream side of the branch flow path inlet 55 has a flow path area that becomes smaller in the direction perpendicular to the paper surface in FIG. 5 toward the rear surface 17. The opening area of the sub-flow path outlet 52 is smaller than the flow path area of the branch flow path 54. As a result, a pressure loss of the air flowing in the portion of the sub-flow path 53 on the downstream side of the branch flow path inlet 55 becomes large, and a part of the air flowing in the sub-flow path 53 easily flows to the branch flow path 54.

The board 20 is arranged at the folded portion 543 of the branch flow path 54. The board 20 is a printed circuit board made of, for example, glass or epoxy resin, and a part the board 20 is resin-molded in the housing 10. A part of the board 20 extends to the physical quantity measuring flow path 60.

A flow rate detection unit 70 is mounted on a portion of the board 20 that is arranged at the folded portion 543 of the branch flow path 54. The flow rate detection unit 70 outputs a signal according to the flow rate of the air flowing through the branch flow path 54. Specifically, the flow rate detection unit 70 includes a semiconductor including a heat generating element, a temperature sensitive element, and the like (not shown). The semiconductor included in the flow rate detection unit 70 comes into contact with the air flowing through the branch flow path 54 and transfers heat with the air flowing through the branch flow path 54. This heat transfer changes the temperature of the semiconductor. The temperature change correlates with the flow rate of the air flowing through the branch flow path 54. Therefore, the flow rate detection unit 70 outputs a signal corresponding to the temperature change, that is, a signal corresponding to the flow rate of the air flowing through the branch flow path 54. The output signal of the flow rate detection unit 70 is transmitted from the wiring of the board 20 to the ECU 112 via the terminals 14. The flow rate detection unit 70 is not limited to the above configuration, and various detection configurations such as a Karman vortex type, a flap type, and a hot wire type may be adopted.

As shown in FIGS. 5 to 7, the physical quantity measuring flow path 60 is a flow path provided separately from the flow rate measuring flow path 50. A flow path inlet 61 of the physical quantity measuring flow path 60 is open in the front surface 16 of the housing main body portion 12. A flow path outlet 62 of the physical quantity measuring flow path 60 is open in each of the right side surface 18 and the left side surface 19 of the housing main body portion 12. The physical quantity measuring flow path 60 includes a direct flow path 63 through which air directly flows from the flow path inlet 61 to the flow path outlet 62, and a physical quantity measuring chamber 64 that communicates with the direct flow path 63 and is formed in a bag shape. Therefore, a part of the air flowing through the intake flow path 102 flows into the direct flow path 63 from the flow path inlet 61 and is discharged from the flow path outlet 62 to the intake flow path 102. At that time, the air in the physical quantity measuring chamber 64 is also replaced with the air flowing through the direct flow path 63.

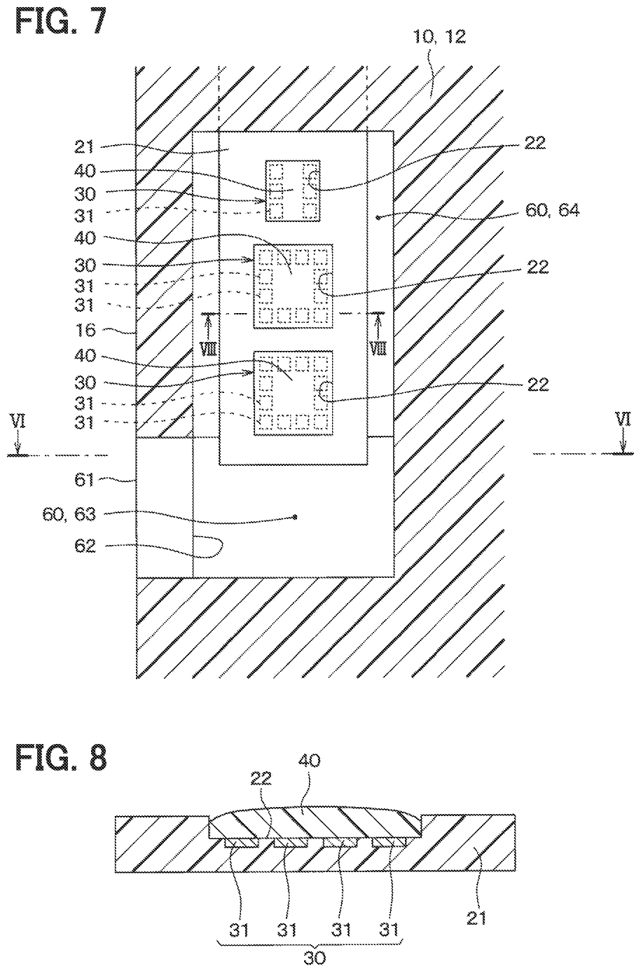

As shown in FIG. 7, a board 21 is also arranged in the physical quantity measuring flow path 60. The board 21 is also a printed circuit board made of, for example, glass or epoxy resin, and a part the board 21 is resin-molded in the housing 10. The wirings of the board 21 is electrically connected to the terminals 14. In this embodiment, the board 21 provided in the physical quantity measuring flow path 60 and the board 20 provided in the flow rate measuring flow path 50 are integrally formed. It is noted that, the configuration is not limited to this. The board 21 provided in the physical quantity measuring flow path 60 and the board 20 provided in the flow rate measuring flow path 50 may be separate members.

The board 21 is provided with a plurality of land portions 30 and the resin coating 40 as the insulating portion. The plurality of land portions 30 are provided at a portion of the board 21 arranged in the physical quantity measuring chamber 64. Each of the plurality of land portions 30 has a plurality of lands 31 on which a physical quantity sensor can be mounted. In other words, the land portion 30 is an area provided with the plurality of lands 31 on which a predetermined physical quantity sensor can be mounted.

The air flow meter 1 of the present embodiment is of a specification in which a physical quantity sensor is not mounted on the plurality of land portions 30. However, a wiring is formed on the board 21 so that the physical quantity sensor can be mounted on the plurality of land portions 30. The physical quantity sensor detects a physical quantity different from the flow rate of the air flowing through the intake flow path 102. Examples of the physical quantity sensor include a pressure sensor and a humidity sensor. The air flow meter 1 of the present embodiment is configured so that the signal output by the physical quantity sensor is output through the wiring of the board 21 even when the specification is modified so that the physical quantity sensor is mounted on the plurality of land portions 30.

As shown in FIGS. 7 and 8, in the present embodiment, the insulating resin coating 40 is provided for each of the plurality of land portions 30 provided on the board 21. The resin coating 40 is provided so as to cover each of the plurality of land portions 30. The resin coating 40 is configured to electrically insulate between the plurality of lands 31 against foreign matter or water contained in the air flowing through the physical quantity measuring flow path 60. Even when foreign matter or water contained in the air flowing through the physical quantity measuring flow path 60 adheres to the resin coating 40, the resin coating 40 prevents the plurality of lands 31 from short-circuiting with each other.

In the present embodiment, the plurality of resin coatings 40 covering the plurality of land portions 30 are made of the same material. The resin coating 40 is formed by, for example, epoxy potting.

Further, in the present embodiment, the portion of the board 21 on which the land portion 30 is formed is a recess portion 22 formed so that the height of the board 21 in the thickness direction is smaller than that of the surrounding portion of the board 21. That is, the land portion 30 is provided in the recess portion 22 of the board 21. Therefore, when the resin coating 40 is formed on the land portion 30 by epoxy potting, it is possible to prevent the resin from flowing out from the recess portion 22 provided with the land portion 30. Therefore, the air flow meter 1 of the present embodiment enables to reliably insulate the plurality of lands 31 from foreign substances and water contained in the air.

In a case where the specification of the air flow meter 1 of the present embodiment is modified to a specification that detects an air pressure, a humidity, and the like in addition to the air flow rate, a physical quantity sensor such as a pressure sensor or a humidity sensor can be mounted on the land portion 30 of the board 21. Therefore, the air flow meter 1 of the present embodiment is configured to be easily switched to have the specification that detects the physical quantities such as the air pressure and the humidity or the specification that does not detect the physical quantities.

The air flow meter 1 of the present embodiment described above is configured to produce the following effects.

(1) The present embodiment is provided with the resin coating 40 that covers the land portion 30 as the insulating portion that insulates electrical conduction between the plurality of lands 31 in the state where the physical quantity sensor is not mounted on the plurality of lands 31 on which the physical quantity sensor is configured to be mounted on the board 21.

According to this configuration, in the state where the physical quantity sensor is not mounted on the land portions 30 of the board 21, the electrical conduction between the plurality of lands 31 is insulated by the resin coating 40. Therefore, the airflow meter enables to use the same board 21 in the specification provided with the physical quantity sensor for detecting the physical quantity of air and the specification not provided with the physical quantity sensor. Therefore, this airflow meter is configured to prevent an increase in the specifications of boards and reduce manufacturing costs.

(2) Further, in the present embodiment, by using the resin coating 40 having a high electrical resistivity as the insulating portion, it is possible to reliably insulate the plurality of lands 31 from each other.

(3) In the present embodiment, the physical quantity sensor that can be mounted on the land portion 30 of the board 21 detects the physical quantity different from the flow rate of the air flowing through the main flow path.

According to this, the air flow meter 1 is enabled to switch easily from the specification, which detects the flow rate of air flowing through the intake flow path 102, to a specification, which detects a physical quantity such as a pressure or a humidity in addition to air flow rate, depending on the model of the vehicle on which the product is installed. That is, the air flow meter 1 is configured to use the same board 21 in the specification which is provided with the physical quantity sensor and the specification which is not provided with the physical quantity sensor.

(4) In the present embodiment, the resin coating 40 is an epoxy potting that covers the land portion 30.

According to this, the land portion 30 can be insulated at a pinpoint.

(5) In the present embodiment, in the board 21, the land portion 30 is provided in the recess portion 22 formed so that the height of the board 21 in the thickness direction is smaller than that of the surrounding portion.

According to this, the insulating resin covering the land portion 30 is prevented from flowing out from the land portion 30. Therefore, the land portion 30 can be reliably insulated.

(6) In the present embodiment, the plurality of resin coatings 40 covering the plurality of land portions 30 are formed of the same material.

According to this, by using the same material for the resin coating 40, the cost of the material can be reduced.

(7) In the present embodiment, the land portion 30 and the resin coating 40 provided on the board 21 are arranged in the physical quantity measuring flow path 60 provided separately from the flow rate measuring flow path 50.

According to this, the physical quantity measuring flow path 60 does not have the sub-flow path 53 and the branch flow path 54 like the flow rate measuring flow path 50. Therefore, there is a demand for insulation of the board 21 on which the physical quantity sensor is not mounted. To this demand, the air flow meter 1 of the present embodiment includes the resin coating 40 that covers the land portion 30. In this way, electrical conduction between the plurality of lands 31 can be steadily insulated, thereby to meet the demand.

### Second Embodiment

A second embodiment will be described. The second embodiment is similar to the first embodiment except for a part of the configuration of the board 21 modified from the corresponding configuration of the first embodiment. Accordingly, only parts different from the corresponding parts of the first embodiment are herein described.

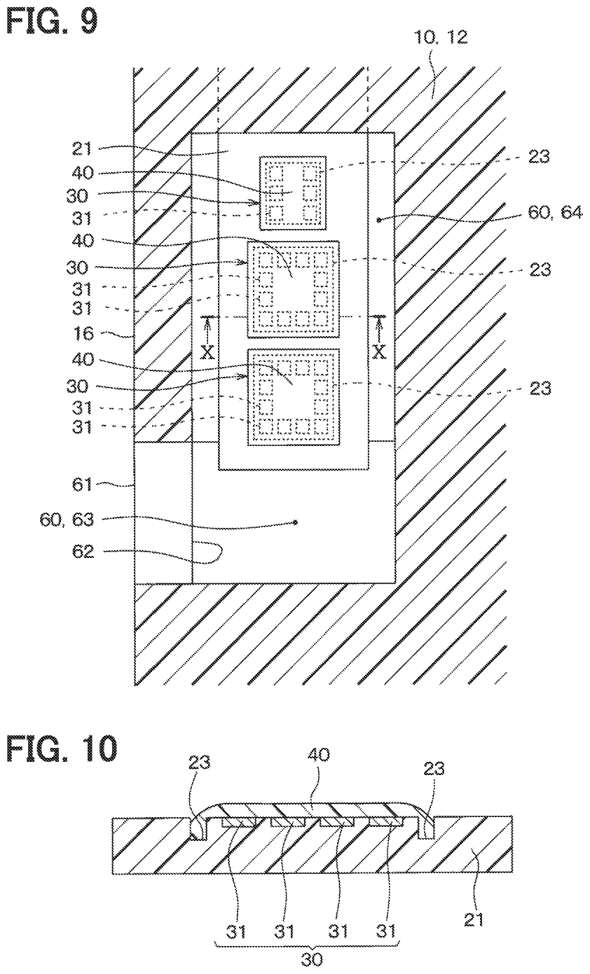

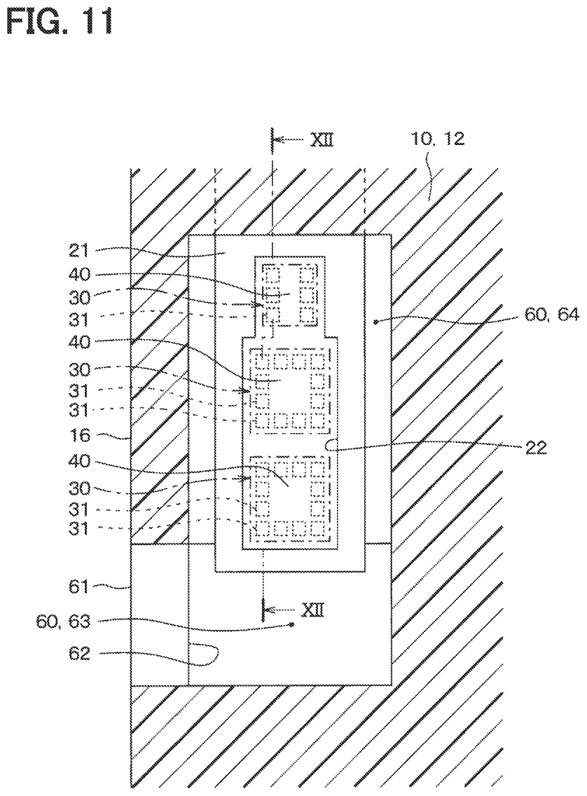

As shown in FIGS. 9 and 10, also in the second embodiment, the plurality of land portions 30 are provided on the board 21 provided in the physical quantity measuring flow path 60. The resin coating 40 as the insulating portion is provided for each of the plurality of land portions 30 provided on the board 21. The resin coating 40 is formed by, for example, epoxy potting.

The board 21 is provided with a groove portion 23 so as to surround the outside of the land portion 30. Therefore, in the second embodiment, when the resin coating 40 is formed on the land portion 30 by epoxy potting, the resin is prevented from flowing out from the groove portion 23 surrounding the land portion 30. Therefore, even with the configuration of the second embodiment, the land portion 30 can be reliably insulated by the resin coating 40.

### Third Embodiment

A third embodiment will be described. The third embodiment is similar to the first embodiment except for a part of the configuration of the board 21 and the insulating portion modified from the corresponding configuration of the first embodiment. Accordingly, only parts different from the corresponding parts of the first embodiment are herein described.

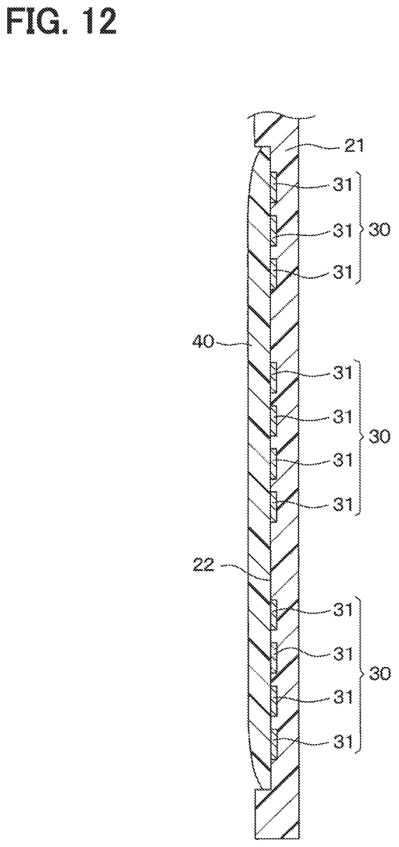

As shown in FIGS. 11 and 12, also in the third embodiment, the plurality of land portions 30 are provided on the board 21 provided in the physical quantity measuring flow path 60. The board 21 is provided with the recess portion 22 formed so that the height in the thickness direction is smaller than that of a surrounding portion. The recess portion 22 is formed in a size in which the plurality of land portions 30 are arranged. Therefore, the plurality of land portions 30 are provided inside the singular recess portion 22 formed in the board 21.

Then, in the third embodiment, the resin coating 40 as the insulating portion integrally covers the plurality of land portions 30. The resin coating 40 is formed by, for example, epoxy potting. Also in the configuration of the third embodiment, when the resin coating 40 is formed on the plurality of land portions 30 by epoxy potting, it is possible to prevent the resin from flowing out from the recess portion 22 provided with the plurality of land portions 30. Therefore, even with the configuration of the third embodiment, the land portion 30 can be reliably insulated by the resin coating 40.

Further, in the third embodiment, the manufacturing cost can be reduced by integrating the resin coating 40 covering the plurality of land portions 30.

### Fourth Embodiment

A fourth embodiment will be described. The fourth embodiment is similar to the third embodiment except for a part of the configuration of the board 21 modified from the corresponding configuration of the third embodiment. Accordingly, only parts different from the corresponding parts of the third embodiment are herein described.

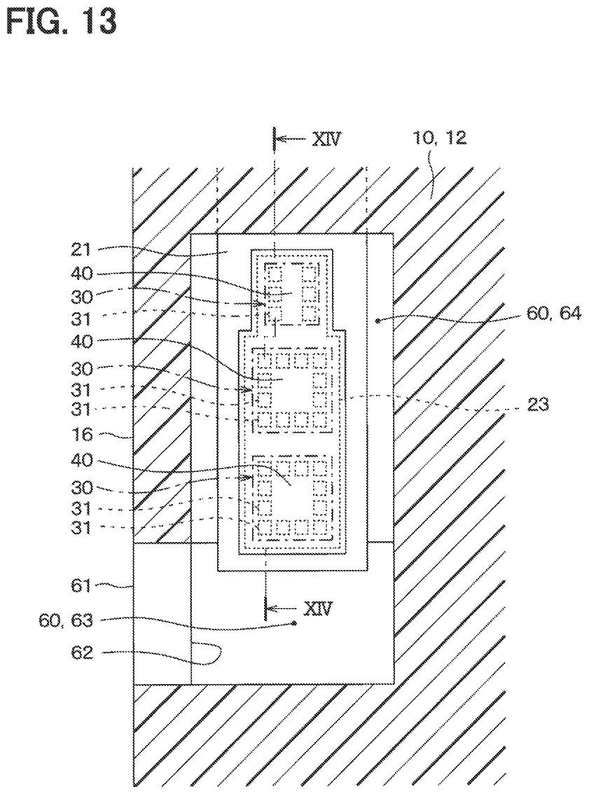

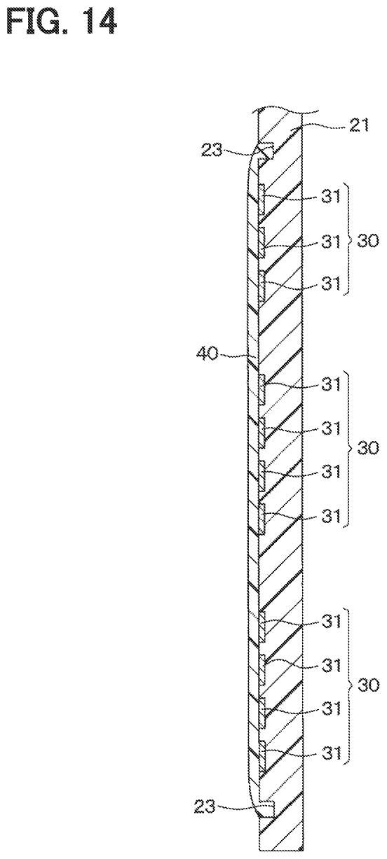

As shown in FIGS. 13 and 14, also in the fourth embodiment, the plurality of land portions 30 are provided on the board 21 provided in the physical quantity measuring flow path 60. The board 21 is provided with the groove portion 23 so as to surround the outside of the plurality of land portions 30. Therefore, the plurality of land portions 30 are provided in an inner region of the groove portion 23 formed in the board 21.

Then, also in the fourth embodiment, the resin coating 40 as the insulating portion integrally covers the plurality of land portions 30. The resin coating 40 is formed by, for example, epoxy potting. Also in the configuration of the third embodiment, when the resin coating 40 is formed on the plurality of land portions 30 by epoxy potting, it is possible to prevent the resin from flowing out from the groove portion 23 surrounding the plurality of land portions 30. Therefore, even with the configuration of the fourth embodiment, the land portion 30 can be reliably insulated by the resin coating 40.

Further, also in the fourth embodiment, the manufacturing cost can be reduced by integrating the resin coating 40 covering the plurality of land portions 30.

### Fifth Embodiment

A fifth embodiment will be described. The fifth embodiment is similar to the first embodiment except for a part of the configuration of the board 21 and the insulating portion modified from the corresponding configuration of the first embodiment and the like. Accordingly, only parts different from the corresponding parts of the first embodiment and the like are herein described.

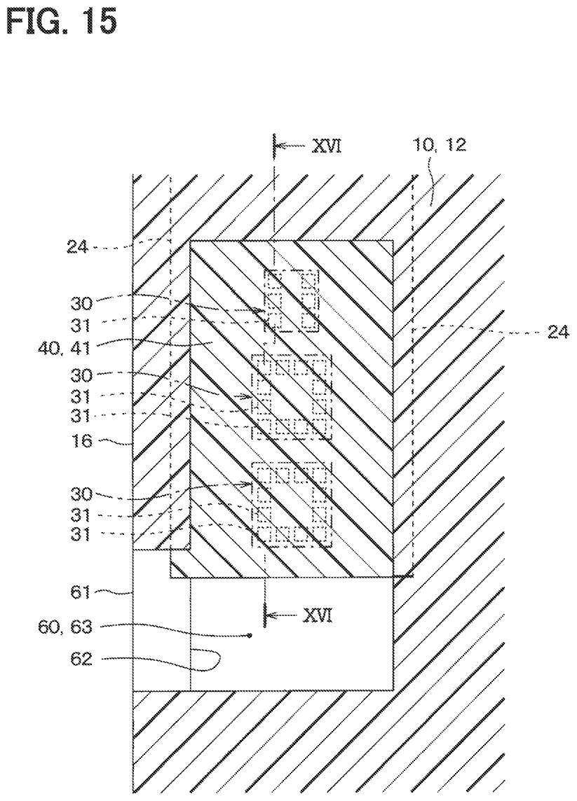

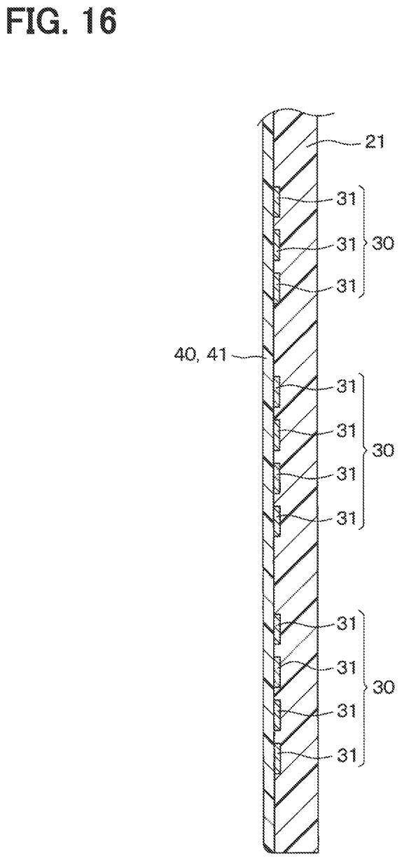

As shown in FIGS. 15 and 16, in the fifth embodiment, an outer edge 24 of the board 21 is molded with the resin forming the housing main body portion 12. Then, in the fifth embodiment, the resin coating 40 as the insulating portion covers the entire surface of the board 21 together with the plurality of land portions 30 provided on the board 21. The resin coating 40 is a resin coat 41. Alternatively, the resin coating 40 may be a gel coating. In a case where the resin coating 40 is a gel coating, a partition plate (not shown) may be provided so that the gel coating does not leak from the board 21 to the physical quantity measuring flow path 60.

In the fifth embodiment described above, the resin coat 41 or the gel coating as the insulating portion enables to insulate the land portion 30 in addition to other portions of the board 21.

### Sixth Embodiment

A sixth embodiment will be described hereafter. The sixth embodiment is similar to the first embodiment except for a part of the configuration of the insulating portion modified from the corresponding configuration of the first embodiment and the like. Accordingly, only parts different from the corresponding parts of the first embodiment and the like are herein described.

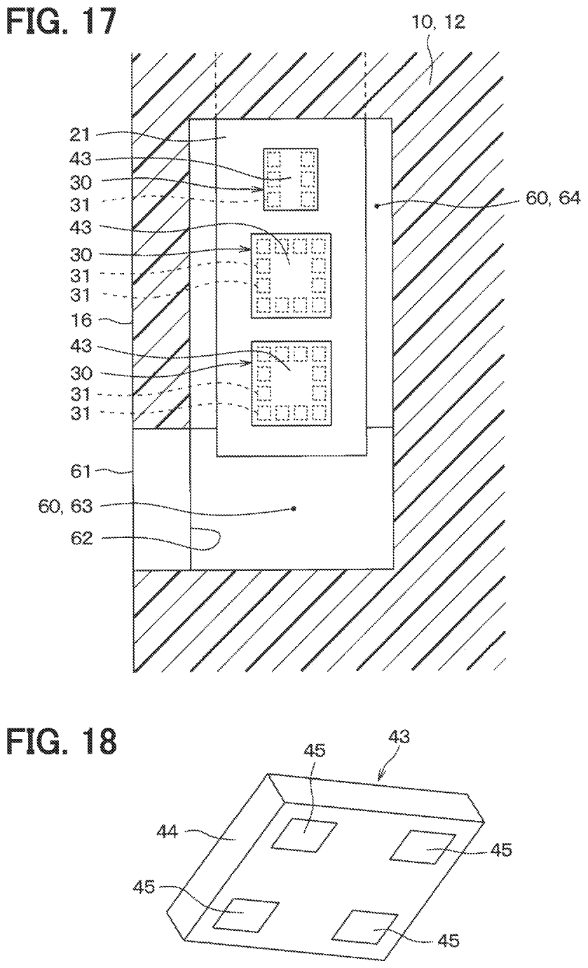

As shown in FIGS. 17 to 19, in the sixth embodiment, the plurality of land portions 30 provided on the board 21 are each covered with a plurality of mounted components 43 as insulating portions. The mounted component 43 is also referred to as a dummy sensor. As shown in FIG. 18, the mounted component 43 includes an insulator 44 such as a resin molded product, and a metal portion 45 provided at a portion of the insulator 44 on the side of the land 31. The mounted component 43 is a component for insulating the electrical conduction between the plurality of land portions 30.

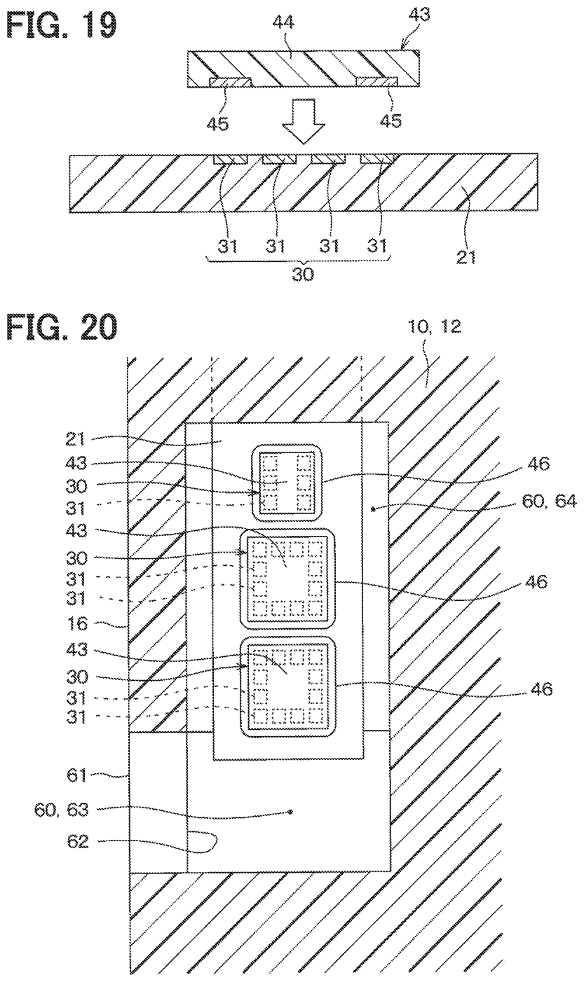

As shown in FIG. 19, in the step of mounting the mounted component 43 on the board 21, a solder paste is applied to the land 31 of the board 21. Then, the mounted component 43 is placed on the board 21 so that the land 31 of the board 21 and the metal portion 45 of the mounted component 43 face each other. At that time, other electronic components may be placed on the board 21 at the same time. Then, it is heated in a reflow oven. As a result, the mounted component 43 and other electronic components are mounted on the board 21.

In the sixth embodiment described above, in the manufacturing process of the air flow meter 1, it is possible to manufacture a product with the specification equipped with the physical quantity sensor and a product with the specification not equipped with the physical quantity sensor in the same manufacturing process line. That is, in the case of the specification that does not include the physical quantity sensor, it is possible to insulate the land portion 30 by mounting the mounted component 43 instead of the physical quantity sensor. Therefore, in the sixth embodiment, the manufacturing process can be simplified.

### Seventh Embodiment

A seventh embodiment will be described. The seventh embodiment is a modification of the sixth embodiment with a configuration in which a part of the insulating portion is modified.

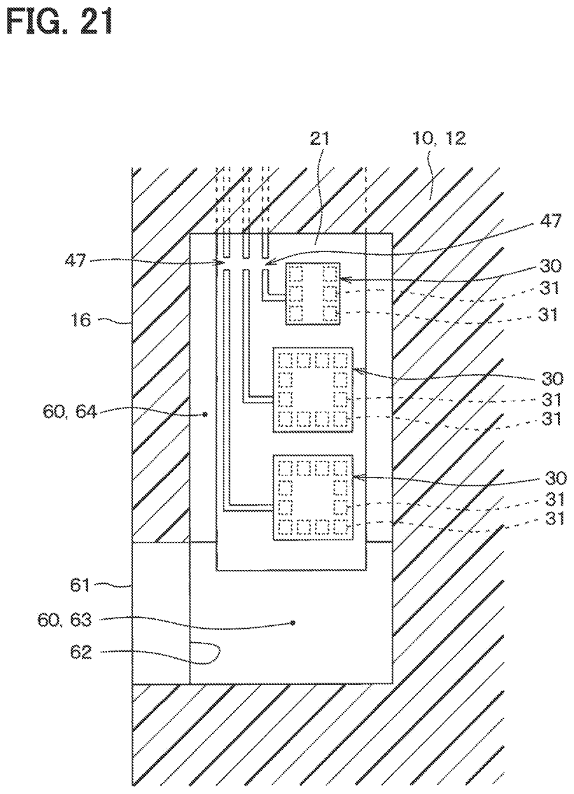

As shown in FIG. 20, also in the seventh embodiment, the plurality of mounted components 43 as insulating portions are mounted on the plurality of land portions 30 provided on the board 21. Further, in the seventh embodiment, a resin potting 46 is provided around the mounted component 43. This prevents foreign matter and water from entering a gap between the mounted component 43 and the board 21. Therefore, it is possible to reliably insulate the plurality of lands 31 arranged on the side of the mounted component 43 which faces the board 21 from each other.

### Eighth Embodiment

An eighth embodiment will be described. The eighth embodiment is similar to the first embodiment except for a part of the configuration of the insulating portion modified from the corresponding configuration of the first embodiment and the like. Accordingly, only parts different from the corresponding parts of the first embodiment and the like are herein described.

As shown in FIG. 21, in the eighth embodiment, the insulating portion for insulating the electrical conduction between the plurality of lands 31 is a wiring division portion 47 in which a portion of wirings formed on the board 21 and extending from the plurality of lands 31 are divided. That is, even in a case where foreign matter or water adheres to the plurality of lands 31, it is possible to prevent the plurality of lands 31 from short-circuiting with each other by dividing a part of the wirings extending from the plurality of lands 31.

Further, the wiring dividing portion 47 as the insulating portion is provided at a position farther than the plurality of lands 31 with respect to a flow path connecting the flow path inlet 61 with the flow path outlet 62 of the physical quantity measuring flow path 60 at the shortest distance. In other words, the wiring dividing portion 47 is provided at a position farther than the plurality of lands 31 with respect to the direct flow path 63 in which air directly flows from the flow path inlet 61 to the flow path outlet 62 in the physical quantity measuring flow path 60. In this way, foreign matter or water contained in the air flowing through the physical quantity measuring flow path 60 is suppressed from adhering to the wiring dividing portion 47. Therefore, the wiring dividing portion 47 enables to steadily prevent the plurality of lands 31 from being short-circuited with each other.

In the configuration of the air flow meter 1 of the eighth embodiment, in order to modify to the specification provided with the physical quantity sensor, the divided wirings may be electrically conducted by soldering to the wiring dividing portion 47. Thus, by mounting a physical quantity sensor such as a pressure sensor or a humidity sensor on the land portion 30, it is possible to detect an air pressure or a humidity.

### Ninth Embodiment

A ninth embodiment will be described. The ninth embodiment is a modification of the above-described first to eighth embodiments in which the configuration of the housing 10 and the like included in the air flow meter 1 is modified.

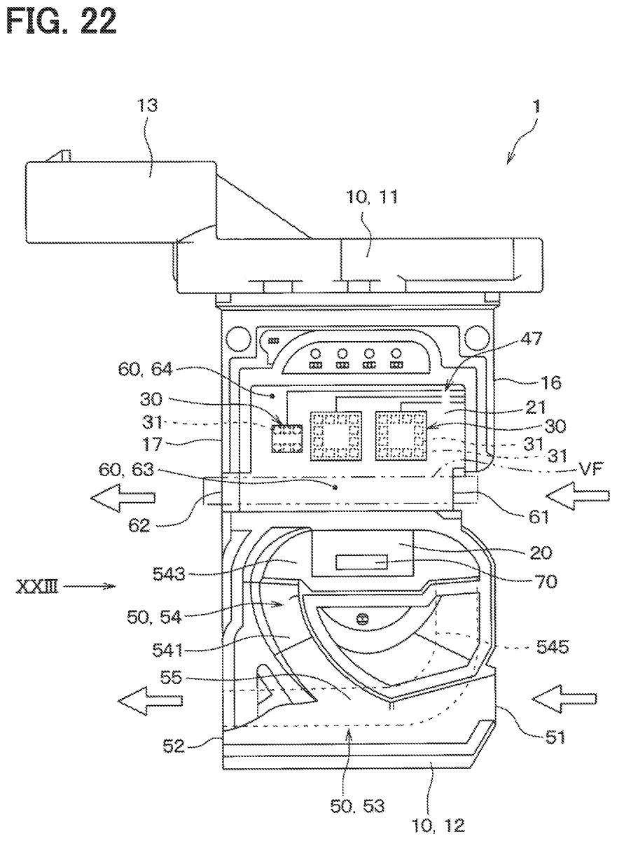

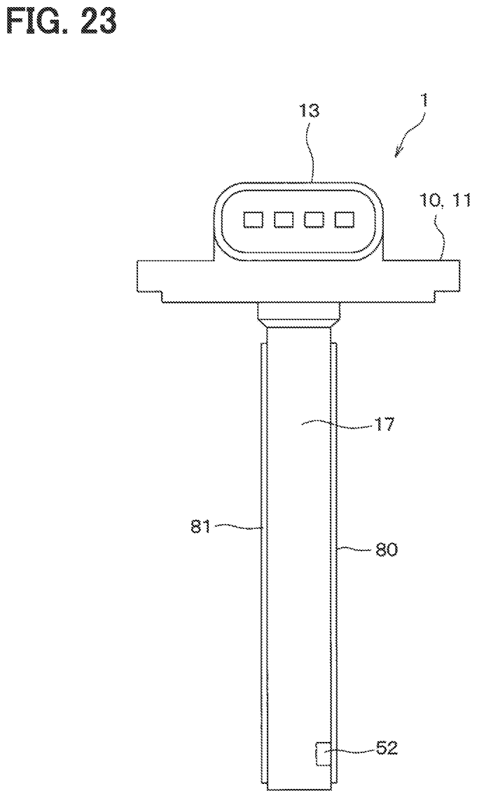

As shown in FIGS. 22 and 23, the housing 10 included in the air flow meter 1 of the ninth embodiment also has the flange portion 11 and the housing main body portion 12 which are integrally formed. The flow rate measuring flow path 50 and the physical quantity measuring flow path 60 are formed in the housing main body portion 12. As shown in FIG. 23, flat plate-shaped lid members 80 and 81 are provided on the right side and the left side of the housing main body portion 12, respectively. The housing main body portion 12 and the lid members 80 and 81 are, for example, welded together by a laser.

The flow rate measuring flow path 50 has the sub-flow path 53 that communicates a sub-flow path inlet 51 with the sub-flow path outlet 52, and the branch flow path 54 that branches from the sub-flow path 53. The branch flow path 54 is a flow path that communicates the branch flow path inlet 55 provided in the middle of the sub-flow path 53 with the branch flow path outlet (not shown) provided in the lid member 81 on the left side of the housing main body portion 12. The branch flow path 54 has the introduction portion 541, the folded portion 543, and a discharge portion 545. The introduction portion 541 is a flow path that communicates with the branch flow path inlet 55 and takes in air from the sub-flow path 53 into the branch flow path 54. The folded portion 543 is provided with the flow rate detection unit 70. The discharge portion 545 is a flow path for discharging the air flowing through the folded portion 543 from the branch flow path outlet 56 to the intake flow path 102. In FIG. 22, the sub-flow path 53 provided on the side of the right side surface of the housing main body portion 12, the introduction portion 541, and the folded portion 543 of the branch flow path 54 are shown by solid lines. Of the branch flow path 54, the discharge portion 545 provided on the side of the left side surface of the housing main body portion 12 is shown by broken lines.

The physical quantity measuring flow path 60 is provided on the side of the flange portion 11 with respect to the flow rate measuring flow path 50. The flow path inlet 61 of the physical quantity measuring flow path 60 is open in the front surface 16 of the housing main body portion 12. The flow path outlet 62 of the physical quantity measuring flow path 60 is open in the rear surface 17 of the housing main body portion 12. The physical quantity measuring flow path 60 includes the direct flow path 63 through which air directly flows from the flow path inlet 61 to the flow path outlet 62, and the physical quantity measuring chamber 64 that communicates with the direct flow path 63 and is formed in a bag shape. In FIG. 22, a range of the direct flow path 63 connecting the flow path inlet 61 with the flow path outlet 62 of the physical quantity measuring flow path 60 at the shortest distance is shown by the alternate long and short dash line VF. A part of the air flowing through the intake flow path 102 flows into the direct flow path 63 from the flow path inlet 61 and is discharged from the flow path outlet 62 to the intake flow path 102. At that time, the air in the physical quantity measuring chamber 64 is also replaced with the air flowing through the direct flow path 63.

The board 21 is arranged in the physical quantity measuring flow path 60. A part of the board 21 also protrudes into the folded portion 543 of the flow rate measuring flow path 50. That is, the board 21 arranged in the physical quantity measuring flow path 60 and the board 20 provided in the folded portion 543 of the flow rate measuring flow path 50 are integrally formed. The outer edge of the board 21 is resin-molded on the housing main body portion 12.

The board 21 is provided with the plurality of land portions 30 and the insulating portion. The plurality of land portions 30 are provided at a portion of the board 21 arranged in the physical quantity measuring chamber 64. Each of the plurality of lands 30 has a plurality of lands 31 on which physical quantity sensors such as a pressure sensor and a humidity sensor may be mounted. In this embodiment as well, the air flow meter 1 has the specification in which a physical quantity sensor is not mounted on the plurality of land portions 30. However, a wiring is formed on the board 21 so that the physical quantity sensor can be mounted on the plurality of land portions 30.

Similar to the eighth embodiment, the insulating portion of the ninth embodiment is the wiring dividing portion 47 in which a part of the wirings among the wirings formed on the board 21 and extending from the plurality of lands 31 are divided. That is, even in a case where foreign matter or water adheres to the plurality of lands 31 provided to the board 21, it is possible to prevent the plurality of lands 31 from short-circuiting with each other by dividing a part of the wirings extending from the plurality of lands 31.

The wiring dividing portion 47 as the insulating portion is provided at a position farther than the plurality of lands 31 with respect to the direct flow path 63 in which air directly flows from the flow path inlet 61 to the flow path outlet 62 in the physical quantity measuring flow path 60. In this way, foreign matter or water contained in the air flowing through the physical quantity measuring flow path 60 is suppressed from adhering to the wiring dividing portion 47. Therefore, the wiring dividing portion 47 enables to steadily prevent the plurality of lands 31 from being short-circuited with each other.

In the configuration of the air flow meter 1 of the ninth embodiment, as the insulating portion, those described in the first to seventh embodiments (that is, the resin coating 40, the epoxy potting, the resin coat 41, the gel coating, the mounted component 43, and the like) may be applied.

### Tenth Embodiment

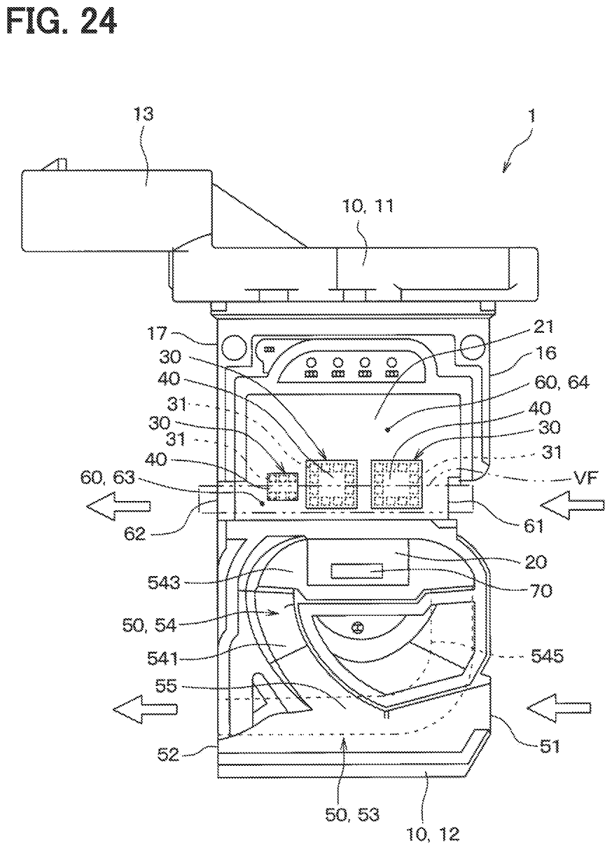

As shown in FIG. 24, the housing 10 included in the air flow meter 1 of the tenth embodiment is similar to that described in the ninth embodiment.

The board 21 arranged in the physical quantity measuring flow path 60 is provided with the plurality of land portions 30 and the resin coating 40 as the insulating portion. The plurality of land portions 30 are arranged in the direct flow path 63 connecting the flow path inlet 61 with the flow path outlet 62 of the physical quantity measuring flow path 60 at the shortest distance. In such a configuration, the environment with respect to foreign matter and water is harsh, and there is a demand for insulation of the board 21 on which the physical quantity sensor is not mounted. On the other hand, also in the tenth embodiment, the air flow meter 1 is provided with the insulating portion for insulating the electrical conduction between the plurality of lands 31. The insulating portion is not limited to the resin coating 40, and those described in the above-described embodiment (that is, the epoxy potting, the resin coat 41, the gel coating, the mounted component 43, the wiring dividing portion 47, and the like) may be applied. Thus, even in the configuration of the tenth embodiment, the air flow meter 1 may comply with the demand for insulation of the board 21 on which the physical quantity sensor is not mounted.

### Eleventh Embodiment

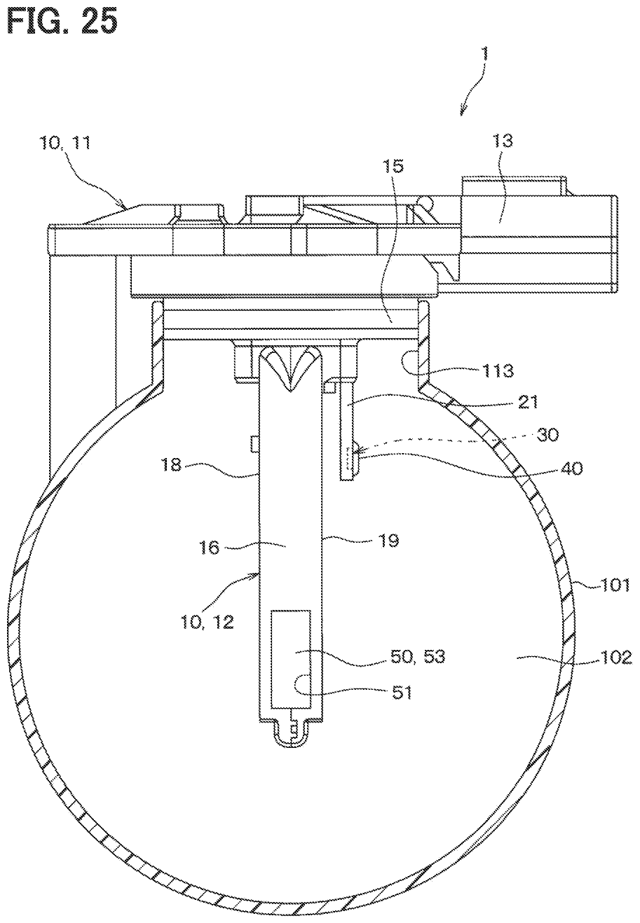

As shown in FIG. 25, in the eleventh embodiment, the board 21 and the land portion 30, on which the physical quantity sensor for detecting a physical quantity such as a pressure and a humidity of the air flowing through the intake flow path 102 may be mounted, are provided outside the housing 10 so as to be exposed to the intake flow path 102.

Also in such a configuration, the environment with respect to foreign matter and water is harsh, and there is a demand for insulation of the board 21 on which the physical quantity sensor is not mounted. On the other hand, also in the tenth embodiment, the air flow meter 1 is provided with the resin coating 40 as an insulating portion for insulating the electrical conduction between the plurality of lands 31. The insulating portion is not limited to the resin coating 40, and those described in the above-described embodiment (that is, the epoxy potting, the resin coat 41, the gel coating, the mounted component 43, the wiring dividing portion 47, and the like) may be applied. Thus, even in the configuration of the eleventh embodiment, the air flow meter 1 may comply with the demand for insulation of the board 21 on which the physical quantity sensor is not mounted.

### Twelfth Embodiment

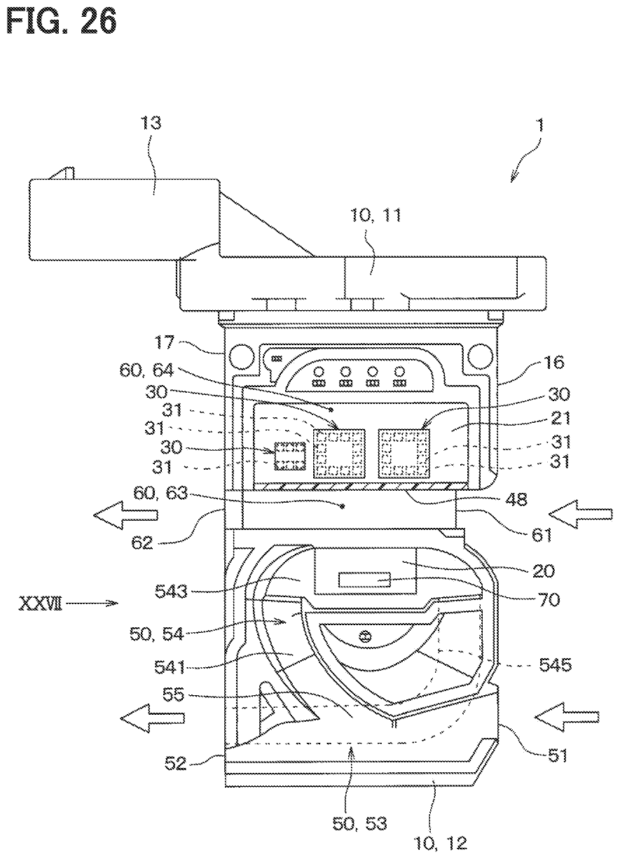

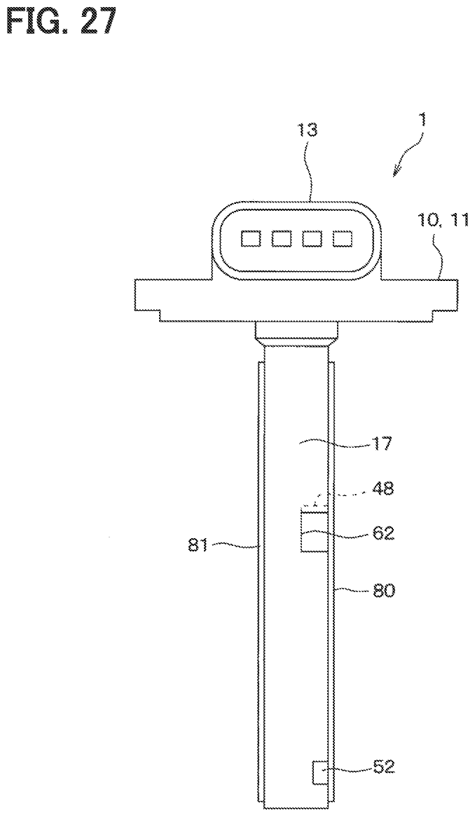

As shown in FIGS. 26 and 27, in the twelfth embodiment, the insulating portion for insulating the electrical conduction between the plurality of lands 31 is a flow path partition plate 48 provided in the lid member 80. The flow path partition plate 48 partitions the physical quantity measuring chamber 64 provided with the land portions 30 of the physical quantity measuring flow path 60 from the direct flow path 63. As a result, in a case where the physical quantity sensor is not provided in the physical quantity measuring chamber 64, in which the physical quantity sensor can be arranged, the flow path partition plate 48 prevents air flowing through the direct flow path 63 from the flow path inlet 61 to the flow path outlet 62 from entering the physical quantity measuring chamber 64 provided with the land portions 30. Therefore, it is possible to prevent foreign matter or water from adhering to the plurality of lands 31 provided on the board 21, and thus it is possible to prevent the plurality of lands 31 from being short-circuited with each other.

### Thirteenth Embodiment

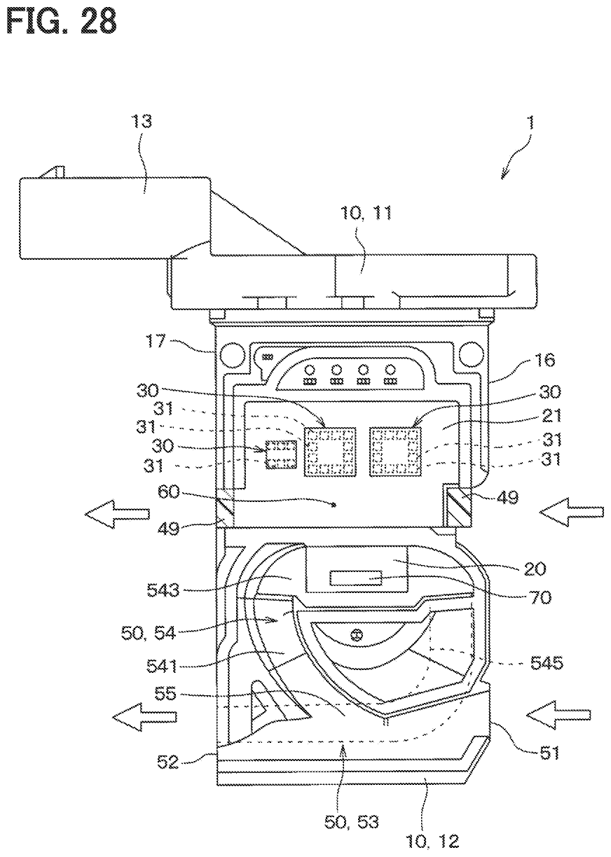

As shown in FIG. 28, in the thirteenth embodiment, the insulating portion for insulating the electrical conduction between the plurality of lands 31 is flow path blocking members 49 provided in the lid members 80, 81. In a case where the physical quantity sensor is not arranged in the physical quantity measuring flow path 60, in which the physical quantity sensor can be arranged, the flow path blocking members 49 close the flow path inlet 61 and the flow path outlet 62 of the physical quantity measuring flow path 60, thereby to prevent air from flowing into the physical quantity measuring flow path 60. In this way, it is possible to prevent foreign matter or water from adhering to the plurality of lands 31 provided on the board 21, and thus it is possible to prevent the plurality of lands 31 from being short-circuited with each other.

### OTHER EMBODIMENTS

The present disclosure is not limited to the embodiments described above, and can be modified as appropriate. The above embodiments are not independent of each other, and can be appropriately combined except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

For example, in the above embodiment, the intake flow path 102 is exemplified as the main flow path, in which the airflow meter 1 is installed, however, the main flow path is not limited to this, and the main flow path may be a flow path through which gas flows.

For example, in the above embodiment, the air flow meter 1 has been described as having the plurality of land portions 30 provided on the board 21, however, the air flow meter 1 is not limited to this, and the air flow meter 1 may have a single land portion 30.

What is claimed is:

1. An air flow rate measuring device configured to detect a physical quantity of air flowing through a main flow path, the air flow rate measuring device comprising:
a housing provided in the main flow path;
a board provided in the housing;
a land portion including a plurality of lands via which the board is configured to be mounted with a physical quantity sensor that is configured to detect the physical quantity of air; and
an insulating portion that electrically insulates between the plurality of lands against foreign matter or water flowing with the air.

2. The air flow rate measuring device according to claim 1, wherein
the physical quantity sensor, which is configured to be mounted on the land portion, is configured to detect a physical quantity that is other than a flow rate of the air flowing through the main flow path.

3. The air flow rate measuring device according to claim 1, wherein
the insulating portion is a resin coating that is insulative and covers the land portion.

4. The air flow rate measuring device according to claim 3, wherein
the resin coating is an epoxy potting that covers the land portion.

5. The air flow rate measuring device according to claim 3, wherein
the resin coating is a gel coating that covers an entirety of the board and the land portion.

6. The air flow rate measuring device according to claim 3, wherein
the resin coating is a resin coat that covers an entirety of the board and the land portion.

7. The air flow rate measuring device according to claim 1, wherein
the land portion is provided to a recess portion formed in the board, and
a height of the recess portion in a thickness direction of the board is smaller than a height of a portion surrounding the recess portion in the board.

8. The air flow rate measuring device according to claim 1, wherein
the board has a groove portion surrounding an outside of the land portion.

9. The air flow rate measuring device according to claim 3, wherein
the board is provided with a plurality of land portions including the land portion, and
the resin coating covering the plurality of land portions is made of a same material.

10. The air flow rate measuring device according to claim 3, wherein
the board is provided with a plurality of land portions including the land portion, and
the resin coating integrally covers the plurality of land portions.

11. The air flow rate measuring device according to claim 1, wherein
the insulating portion is a mounted component including an insulator, which is provided to the land portion, and a metal portion, which is provided to a portion of the insulator on a side of the land.

12. The air flow rate measuring device according to claim 11, further comprising:
a resin potting provided around the mounted component.

13. The air flow rate measuring device according to claim 1, wherein
the insulating portion is a wiring dividing portion of a wiring, which is formed on the board and extends from the plurality of lands, and
a part of the wiring is divided in the wiring dividing portion.

14. The air flow rate measuring device according to claim 13, wherein
the housing has a physical quantity measuring flow path configured to supply the air flowing through the main flow path to a region, which is configured to be provided with the physical quantity sensor,
the wiring dividing portion is provided at a position farther from a flow path than the plurality of lands, and
the flow path connects a flow path inlet with a flow path outlet of the physical quantity measuring flow path at a shortest distance.

15. The air flow rate measuring device according to claim 1, wherein
the housing has a physical quantity measuring flow path configured to supply the air flowing through the main flow path to a region, which is configured to be provided with the physical quantity sensor, and
the insulating portion is
a flow path partition plate configured to partition a part of the physical quantity measuring flow path in a configuration, in which the physical quantity sensor is not provided in a region where the physical quantity sensor is configured to be provided, so that the air flowing through the main flow path does not flow into the region where the physical quantity sensor is configured to be provided, or
a flow path blocking member that closes a flow path inlet and a flow path outlet of the physical quantity measuring flow path.

16. The air flow rate measuring device according to claim 1, wherein
the housing has
a flow rate measuring flow path including a sub-flow path, which communicates a sub-flow path inlet with a sub-flow path outlet that open in the main flow path, and a branch flow path, which branches from the sub-flow path, and
a physical quantity measuring flow path, which is provided separately from the flow rate measuring flow path and communicates a flow path inlet with a flow path outlet that open in the main flow path, and
the land portion is arranged in the physical quantity measuring flow path.

17. The air flow rate measuring device according to claim 16, wherein
the land portion is provided in a flow path that connects the flow path inlet with the flow path outlet of the physical quantity measuring flow path at a shortest distance.

18. The air flow rate measuring device according to claim 3, wherein
the board is provided outside the housing, and
the land portion, which is provided to the board, or the resin coating, which covers the land portion, is exposed to the main flow path.
